(19) United States
(12) Patent Application Publication
(10) Pub. No.: US 2011/0135949 A1
(43) Pub. Date: Jun. 9, 2011

(54) Metal-Coated Plastic Articles and Methods Therefor

(75) Inventor: Andri E. Elia, Chadds Ford, PA (US)

(73) Assignee: E. I. DU PONT DE NEMOURS AND COMPANY, Wilmington, DE (US)

(21) Appl. No.: 12/960,852

(22) Filed: Dec. 6, 2010

Related U.S. Application Data
(60) Provisional application No. 61/267,543, filed on Dec. 8, 2009.

(51) Int. Cl. B32B 15/04; B05D 3/10

(52) U.S. Cl. 428/457; 427/322

(57) ABSTRACT

Disclosed herein is a method for surface treating a polymeric article using a combination of an acidic solution and a bifluoride solution, in any order. Such surface treated polymeric articles, when coated with a metal, have superior metal to polymer bonding properties. Useful applications include automotive grill-guards; brake, gas or clutch pedals; fuel rails; running boards; spoilers; muffler tips; wheels; vehicle frames; and structural brackets.

### FIELD OF THE INVENTION

This invention relates in part to processes wherein a polymeric article is chemically treated prior to applying a metal coating, and such metal coated articles.

### BACKGROUND OF THE INVENTION

It is well known that when a metal is coated as a layer onto a polymeric article, that a tenacious bonding of the metal to the article surface is highly desired.

U.S. Pat. No. 5,192,590 discloses that a surface of a poly(aryl ether ketone) composition with substantial amounts of glass and/or mineral filler is subjected to a solution of ammonium bifluoride and sulfuric acid. Complete dissolution of all exposed glass and mineral fillers can be completed by a further immersion in 25% sulfuric acid in water for 10 to 30 minutes.

The object of the present disclosure is to provide a method for achieving a metal coating onto the surface of a polymeric article wherein the bond strength of the metal to the polymeric surface is extremely strong, and therefore improved.

### BRIEF SUMMARY OF THE INVENTION

The technical solution described herein for fulfilling this need has been to provide a process for coating a polymeric article. Specifically, described herein are processes comprising the steps of:

i) treating the polymeric article with an acidic solution to obtain an acid treated polymeric article;

ii) treating the acid treated polymeric article with a bifluoride solution having a pH which is higher than (i) to obtain a bifluoride treated polymeric article; and

iii) applying a metal coating to the bifluoride treated polymeric article to obtain a metal coated polymeric article;

wherein the metal-coated polymeric article has a peel strength which is at least 25% greater than a metal-coated polymeric article treated only with steps (i) and (iii) or treated only with steps (ii) and (iii).

Also described herein are processes describing the steps of:

iv) treating the polymeric article with an acidic solution to obtain an acid treated polymeric article;
a) treating the acid treated polymeric article with a bifluoride solution having a pH which is higher than (iv) to obtain a bifluoride treated polymeric article; and

v) applying a metal coating to the bifluoride treated polymeric article to obtain a metal coated polymeric article;

wherein the metal-coated polymeric article has a peel strength which is at least 25% greater than a metal-coated polymeric article in which steps (iv) and (v) are performed in a single step using one solution comprising the components of the acidic and bifluoride solutions.

Also described herein are articles prepared by the process of the invention.

### BRIEF DESCRIPTION OF THE SEVERAL VIEWS OF THE DRAWING(S)

FIG. 1 is a flow chart of a method of the prior art.

FIG. 2 is a flow chart of an inventive method described herein.

### DETAILED DESCRIPTION OF THE INVENTION

### Definitions

As used herein, the article “a” indicates one as well as more than one and does not necessarily limit its referent noun to the singular.

As used herein, the terms “about” and “at or about” mean that the amount or value in question may be the value designated or some other value approximately or about the same. The term is intended to convey that similar values promote equivalent results or effects recited in the claims.

As used herein, the terms “comprises,” “comprising,” “includes,” “including,” “has,” “having” or any other variation of these, refer to a non-exclusive inclusion. For example, a process, method, article, or apparatus that comprises a list of elements is not limited to only the listed elements but may include other elements not expressly listed or inherent. Further, unless expressly stated to the contrary, “or” refers to an inclusive, not an exclusive, or.

As used herein, the term “polymeric article” means a molded three dimensional shape of a polymeric composition. Such three dimensional polymeric articles include, but are not limited to, structural components suited for high temperature applications, toys, appliances, power tools, industrial machinery, electronic devices (e.g., personal electronic devices (PEDs) such as cell phones, personal digital assistants (PDAs), music storage and listening devices (e.g. i-Pods®), and portable DVD players), electrical multimeters, mobile electronic game consoles, and mobile personal computers (such as notebook computers, etc.). The polymeric article may be both visible and nonvisible, that is they may be in the interior of the PED, such as full or partial “frame” around the periphery of the PED, one or more separate beams and/or a number of beams in the form of a latticework, or any combination of these.

As used herein, the term “acidic solution” means a solution which has a pH of less than or equal to 5.0, preferably 3, and more preferably less than or equal to 2.5. Solution pH is measured by hydrogen ion content (H+). The solution does not contain hydrogen bifluoride anions.

As used herein, the term “bifluoride solution” means a solution comprising hydrogen bifluoride anion (HF₂) and having a pH of greater than 2.5, preferably greater than 3.

As used herein, the term “metal coating” means a coating of metal on a polymeric article surface where the coating completely or partially coats the surface desired to be coated with metal. In some applications it is desired that the polymeric article be partially coated. The coating comprises a metal in elemental form, a metal alloy, or a metal matrix composition. The coating is bonded to the surface of the polymeric article.

As used herein, the term “single solution” means one solution which comprises all the components of the solution.

As used herein, the term “step” means performing an operation on a polymeric article surface. The operation can be a chemical treatment, such as with an acidic solution, or the operation can be a water wash of the polymeric article surface to remove residual components from a previous operation. A step may include multiple operations. For example, a step may include treatment of a polymeric surface with an acidic solution, followed by a water wash, followed by an untrasonic wash, followed by another acid wash (using the same acidic solution), followed by multiple water washes in which all these operations are considered one step.

Many articles are made with polymer compositions having a metal coating. Such metal coated articles are suitable for applications where it is desirable for the metal coating to be strongly bonded onto the polymeric article surface rather than be easily removed or compromised in normal use of the metal coated article. This desirable property can be assessed by measuring the peel strength of the metal coated article.

Typically, to obtain a strong bond between the polymeric article and the metal, the surface of the polymeric article is treated either mechanically or chemically to roughen the polymer surface in an effort to increase the metal to polymer bond strength. This invention relates to novel processes to chemically modify the polymeric surface of an article to increase the metal to polymer bond strength.

### Polymeric Article

Suitable polymeric articles that can be used to manufacture a metal coated article can comprise one or more polymers, and one or more additives such as fiber(s), particle(s), filler(s), stabilizer(s), and the like, where a surface of the polymeric article is coated by at least one metal.

Various polymers can be used to manufacture the polymeric articles of the invention. These include polyamide polymers, acrylonitrile/butadiene/styrene (ABS) polymers, styrenic polymers, as well as other polymeric materials solely or in combinations. Polyamide and ABS polymers are preferred polymers for use in this invention. Polyamide polymers are especially preferred.

The polymeric article can be formed by molding a polymer composition using conventional processes such as injection molding, compression molding, thermoforming, compression-injection molding, and similar processes.

### Polyamide Polymers

Polyamide polymers used in the manufacture of the metal coated articles of the invention are condensation products of one or more dicarboxylic acids and one or more diamines, and/or one or more aminocarboxylic acids, and/or ring-opening polymerization products of one or more cyclic lactams. The polyamide polymers are selected from fully aliphatic polyamide polymers, semi-aromatic polyamide polymers and mixtures thereof. The term “semi-aromatic” (which may also be referred to in other printed publications as “partially aromatic”) describes polyamide polymers that comprise at least some aromatic carboxylic acid monomer(s) and aliphatic diamine monomer(s), in comparison with “fully aliphatic” which describes polyamide polymers comprising aliphatic carboxylic acid monomer(s) and aliphatic diamine monomer(s).

Fully aliphatic polyamide polymers are formed from aliphatic and alicyclic monomers such as diamines, dicarboxylic acids, lactams, aminocarboxylic acids, and their reactive equivalents. A suitable aminocarboxylic acid includes 11-aminododecanoic acid. Suitable lactams include caprolactam and laurolactam. In the context of this invention, the term “fully aliphatic polyamide resin” refers to copolymers derived from two or more such monomers and blends of two or more fully aliphatic polyamide polymers. Linear, branched, and cyclic monomers may be used.

Carboxylic acid monomers useful in the preparation of fully aliphatic polyamide polymers include, but are not limited to, aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Useful diamines include those having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine and/or mixtures thereof. Suitable examples of fully aliphatic polyamide polymers include poly(ε-caprolactam) PA6; poly(hexamethylene hexanediamide) (PA6,6); poly (2-methylpentamethylene hexanediamide (PAD,6); poly(pentamethylene decanediamide) (PA5,10); poly(tetramethylene hexanediamide) (PA4,6); poly(hexamethylene decanediamide) (PA6,10); poly(hexamethylene dodecanediamide) (PA6,12); poly(hexamethylene tridecanediamide) (PA6,13); PA6,14; poly(hexamethylene pentadecanediamide) (PA6,15); PA6,16; poly(11-aminoundecanamide) (PA11); poly(12-aminododecanamide) (PA12); PA10; PA 9,12; PA9,13; PA9,14; PA9,15; PA6,16; PA9,36; PA10,10; PA10,12; PA10,13; PA10,14; PA12,10; PA12,12; PA12,13; PA12,14 and copolymers and blends of the same. Preferred examples of fully aliphatic polyamide polymers comprised in the polyamide composition described herein include PA6, PA11, PA12, PA4,6, PA6,6, PA,10; PA6,12; PA10,10 and copolymers and blends of the same.

Semi-aromatic polyamide polymers are homopolymers, copolymers, terpolymers, or higher polymers wherein at least a portion of the acid monomers are selected from one or more aromatic carboxylic acids. The one or more aromatic carboxylic acids can be terephthalic acid or mixtures of terephthalic acid and one or more other carboxylic acids, like isophthalic acid, substituted phthalic acid such as for example 2-methylterephthalic acid and unsubstituted or substituted isomers of naphthalenedicarboxylic acid, wherein the carboxylic acid component preferably contains at least 55 mole-% of terephthalic acid (the mole-% being based on the carboxylic acid mixture). Preferably, the one or more aromatic carboxylic acids are selected from terephthalic acid, isophthalic acid and mixtures thereof and more preferably, the one or more carboxylic acids are mixtures of terephthalic acid and isophthalic acid, wherein the mixture preferably contains at least 55 mole-% of terephthalic acid. Furthermore, the one or more carboxylic acids can be mixed with one or more aliphatic carboxylic acids, like adipic acid; pimelic acid; suberic acid; azelaic acid; sebacic acid and dodecanedioic acid, adipic acid being preferred. More preferably the mixture of terephthalic acid and adipic acid comprised in the one or more carboxylic acids mixtures of the semi-aromatic polyamide resin contains at least 25 mole-% of terephthalic acid. Semi-aromatic polyamide polymers comprise one or more diamines that can be chosen among diamines having four or more carbon atoms, including, but not limited to tetramethylene diamine, hexamethylene diamine, octamethylene diamine, nonamethylene diamine, decamethylene diamine, 2-methylpentamethylene diamine, 2-ethyltetramethylene diamine, 2-methyloctamethylene diamine; trimethylhexamethylene diamine, bis(p-aminocyclohexyl)methane; m-xylene diamine; p-xylene diamine and/or mixtures thereof. Suitable examples of semi-aromatic polyamide polymers include poly(hexamethylene terephthalamide) (polyamide 6,T), poly(nonamethylene terephthalamide) (polyamide 9,T), poly(decamethylene terephthalamide) (polyamide 10,T), poly(dodecamethylene terephthalamide) (polyamide 12,T), hexamethylene adipamide/hexamethylene terephthalamide copolyamide (polyamide 6,T/6,6), hexamethylene terephthalamide/hexamethylene isophthalamide (6,T/6,I), poly(m-xylene adipamide) (polyamide MXD,6), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T), hexamethylene adipamide/hexamethylene terephthalamide/hexamethylene isophthalamide copolyamide (polyamide 6,6/6,T/6,I); poly(caprolactam-hexamethylene terephthalamide) (polyamide 6/6,T) and copolymers and blends of the same. Preferred examples of semi-aromatic polyamide polymers comprised in the polyamide composition described herein include PA6,T; PA6,T/6,6, PA6,T/6,I; PAMXD,6; PA6,T/D,T and copolymers and blends of the same.

The numerical suffix of the polyamide specifies the numbers of carbons donated by the diamine and the diacid. The diamine first and the diacid second. For example, polyamide 6,6 is a polyamide prepared from hexamethylenediamine and hexane-1,6-dicarboxylic acid repeat units and polyamide 66/612 copolymer is a blend of polyamide 6,6 and polyamide 6,12.

The well known nomenclature for polyamide monomers, homopolymers, copolymers, terpolymers, etc. as used within U.S. Pat. No. 6,140,459 (herein incorporated by reference) is followed.

Physical blends of aliphatic polyamides and semiaromatic polyamides are useful in articles to obtain properties intermediate between or synergistic of the properties of each polyamide. However, it has been noted that semiaromatic polyamides in comparison to aliphatic polyamides are more difficult to coat with a metal or metals that remains tenaciously bonded to the surface as desired, and physical blends containing semiaromatic polyamide and aliphatic polyamide can be more difficult to coat than the same aliphatic polyamide. Blends may be expressed by known abbreviations, such as PA6T/DT for a blend of two polyamides, PA6T and PADT. Some amount of copolymers may also be present.

A preferred polyamide composition of the invention is a blend of an aliphatic and a semiaromatic polyamide. One such preferred blend is a blend having an aliphatic polyamide with mostly (>50%) or almost all (>90%) hexamethylene adipamide, or poly(hexamethylene adipamide) itself, optionally in combination with a semiaromatic polyamide having mostly (>50%) or almost all (>90%) hexamethylene terephthalamide monomer and/or hexamethylene isophthalamide monomer with the ratio of the two being greater than or less than or equal to one or more of 0.2, 0.5, or 0.8 (e.g. copoly(hexamethylene isophthalamide (0.666 parts)-hexamethylene terephthalamide (0.334)).

The blend composition of aliphatic and semiaromatic polyamide comprises from about 80 weight percent to about 20 weight percent of aliphatic polyamide and from about 20 weight percent to about 80 weight percent semiaromatic polyamide, preferably from about 70 weight percent to about 30 weight percent of aliphatic polyamide and from about 30 weight percent to about 70 weight percent semiaromatic polyamide. The weight percentages are based on the total weight of the aliphatic and semiaromatic polyamide.

### Fibers/Fillers

The polymeric article suitable for metal coating may comprise one or more fiber(s). Each fiber can be chopped into various fiber lengths or “continuous” and have various diameters, cross sections, lengths, and aspect ratios. Such fibers are used as reinforcing fibers for the polymeric article. The fiber may comprise ingredients such as glass, carbon, graphite, and polymer. A preferred fiber for use in the invention is short chopped glass fibers with a flattened cross section, in a ratio by weight to the polymeric material of about 0.2, 0.5, 1, 2, or 5. The preferred weight percentage of fiber used in the polymeric article of the invention may be from about 10 to about 70 weight percent, based on the total weight percent of the polymer(s) and fiber(s) in the polymeric article.

An optional ingredient of a polymer composition is one or more mineral fillers, such as calcium carbonate particles, clay particles, or the like. The filler can have various average diameters, cross sections, lengths, and aspect ratios. A preferred filler is calcium carbonate particles, The weight percentage of filler used in the polymeric article of the invention may be from about 1 weight percent to about 60 weight percent based on the total weight percent of all the components of the polymeric article before metal coating.

A polymer composition can optionally include other ingredients, such as catalyst, polymers other than polyamide or the like, adhesion promoters, ions, compounds, preservatives, or the like as known in the art.

### Polymeric Article Surface Treatment

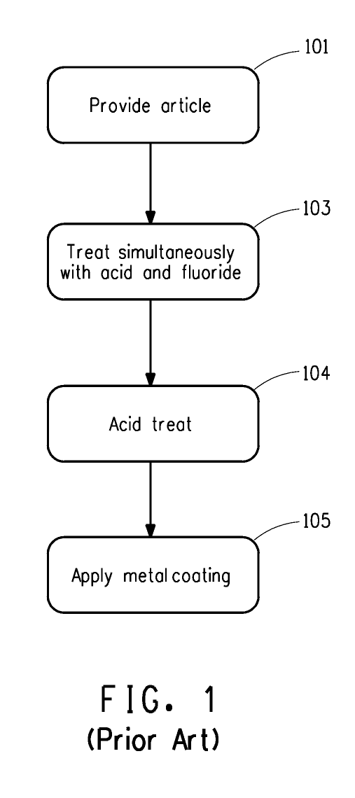

FIG. 1 is a flowchart of a prior art method (U.S. Pat. No. 5,192,59) of metal coating a polymeric article. In the prior art method, an article (one specifically comprising poly(aryl ether ketone) is provided [101], which is treated simultaneously [103] (e.g. to swell the article) with fluoride compounds (hydrofluoric acid, fluorosulfuric acid, trifluorosulfonic acid, niobium pentafluoride, and the like), and an acid (for example, strong acids, super acids, etc.). Thereafter, the article is metal coated [110] by plating.

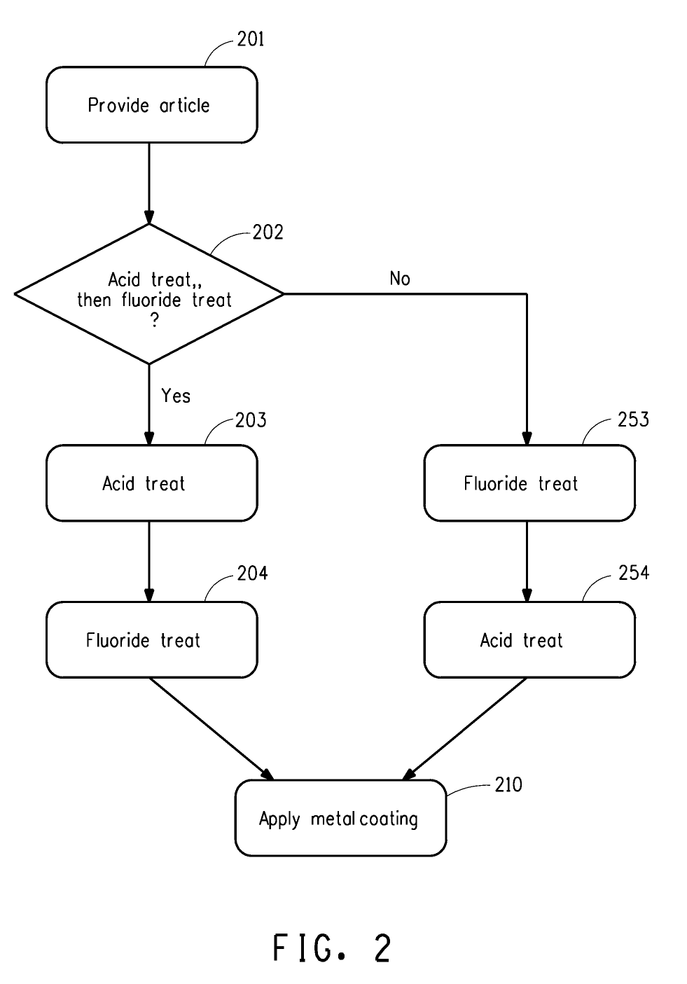

FIG. 2 represents a basic flowchart for the method disclosed herein. An article comprising at least one polyamide optionally with a filler such as mineral filler, or glass fiber, or both is provided [201], and treatment is chosen [202] by acid [203] then fluoride [204], or fluoride [253] then acid [254], and subsequently the treated article is metal coated (e.g. by electrolysis, electrolytically, or the like, optionally with pretreatments to improve metallization).

Various methods can be used to modify an article surface for subsequent metal coating such as swelling, etching, mechanical roughening, illumination, heating, treatment with catalysts, and the like. Such methods can be used sequentially, in which case it can be appropriate to carry out pretreatments or post treatments such as washing, cleaning, drying, heating, partial or full neutralization of pH extremes; while optionally treated with agitation or ultrasonification.

During the treatment of the surface of an article before or during metal coating, it is possible to etch, oxidize, loosen, dissolve, or otherwise selectively remove or change the surface to improve eventual metal adhesion tenacity to the surface. Treatments by acidic or basic pH treating fluids can accomplish this goal; for example an acid-etchable ingredient like calcium carbonate can be treated by an acidic treating fluid, or a base-etchable material such as zinc oxide or citric acid may be removed by a basic fluid. However, for purposes of this invention, only acidic surface treatment chemicals/solutions are used.

One method of carrying out surface preparation of the polymeric article of the invention is by exposure of at least part of an article to an acidic solution. The acidic solution can have dissolved, dispersed, or undissolved components, and can include one or more solvents. One such solvent is ethylene glycol. The dissolved and undissolved components can include ions, ionic and covalent compounds including organic compounds, elements, and the like, including but not limited to hydronium ion, hydroxide ion, chloride ion, sulfate ion, bisulfate ion, fluoride ion, ammonium ion, sodium ion, ionic and elemental metals such as iron, nickel, cobalt, chromium, and similar metals in charge states such as 0, +1, +2, and +3, or compounds such as hydrogen chloride. The amount of any component of a treating liquid mixture can be greater than, equal to, or less than one or more of 0.1, 1, 5, 10, 30, 50, 90, or 95 weight percent.

Acidic solution pH can be an important aspect of treatment, as can treating temperature, agitation and time. Acidity can be established by the use of acids such as inorganic acids such as hydrochloric acid, sulfuric acid, nitric acid, hydrofluoric acid, or the like; or organic acids such as oxalic acid, acetic acid, benzoic acid, or the like. Buffers can be used, established by the presence of one or more of bicarbonate, bisulphate, or similar buffers, with one or more of carbonic acid, carbonate, hydrofluoric acid, fluoride, sulphuric acid, sulfate, or the like.

One such method for acid treating a polymeric article surface and subsequent metallization is described in a technical brochure from Dow Chemical titled “Addiposit™ PM Process” which describes a process for the metallization of polyamide 6 and 6,6. This method uses a hydrochloric acid solution to chemically treat or etch the polymeric article surface followed by surface activation with palladium ions and metallization using electrolytic and electroless coating methods and the like.

Treating the polymeric article surface with two different acidic solutions of different pH provides polymeric article surfaces which upon subsequent metallization, provides metal coated polymeric articles having considerably (greater than 25% improvement in peel strength) stronger bonding between the metal and the polymeric surface compared to bond strengths where a bifluoride solution (a weaker acid solution than acidic solution) is not used or where the polymeric article is treated with a solution containing both the bifluoride solution (weaker acid solution) and acidic solution in a single step.

In one aspect of the invention, surface treatment of the polymeric article is performed in two separate steps using an acidic solution and a bifluoride solution. Treatment with the acidic solution can occur before or after treatment with the bifluoride solution. Additional acid or bifluoride treatments or a combination of these can be carried out more than once as long as the acid and bifluoride treatments are conducted as separate steps.

One step involves treating the polymeric article with an acidic solution of a strong acid such as hydrochloric acid, sulfuric acid, nitric acid, hydrofluoric acid, or similar strong acids; or organic acids such as oxalic acid, acetic acid, benzoic acid, or similar organic acids. Acid treatments are carried out at from about 20° C. to about 85° C., optionally under atmosphere (air, nitrogen, argon or the like) for about 10 to 30 minutes.

The other step involves treating the polymeric article with a bifluoride solution. The bifluoride solution comprises a bifluoride compound such as ammonium hydrogen bifluoride (NH₄HF₂), sodium hydrogen bifluoride (NaHF₂), lithium hydrogen bifluoride (LiHF₂), or potassium hydrogen bifluoride (KHF₂). Preferred bifluoride compounds include ammonium hydrogen bifluoride (NH₄HF₂) and sodium hydrogen bifluoride (NaHF₂) with ammonium hydrogen bifluoride (NH₄HF₂) most preferred.

Fluoride treatments are carried out at ambient conditions, for about 2 to about 30 minutes, preferably from about 5 min to about 15 minutes, and most preferably from about 8 to about 12 minutes.

It is preferred that these acidic treatments are carried out at different pH. In the present invention, it is preferable that the pH of the bifluoride treatment is higher (less acidic) than the pH of the strong acid treatment. Preferably the pH of the bifluoride solution is no less than 2.5, while it is preferred that the pH of the acidic solution is below 2.5. Bifluoride treatment can be carried out before or after or before and after any acid treatment. Additional acid or bifluoride, or both, treatments can be carried out more than once.

### Metallization Process

The metal coating process used in this invention to coat the surface treated polymeric article is any metallization process known in the art to coat a surface treated polymeric article with a metal layer. One such metallization process is disclosed in the Dow Chemical brochure titled ““Addiposit™ PM Process”.

The metal coatings can comprise at least one metal, alloys of such, or metal matrix composites. The metal coatings can be from about 0.1 micron to several hundred microns thickness. Preferably, the metal coating thickness is from about 5 microns to about 400 microns, more preferably from about 20 microns to about 200 microns, and still more preferably from about 30 microns to about 100 microns thickness. The metal coatings can comprise multiple layers of various metals.

Applications where favorable or improved peel strength is desirable include high temperature components, aerospace parts, defense parts, consumer products, medical components and sporting goods. Suitable parts include, among others, tubes or shafts used for example in sporting goods such as ski and hiking poles, fishing rods, golf club shafts, hockey sticks, lacrosse sticks, baseball/softball bats, bicycle frames, skate blades, snow boards; plates, such as golf club head face plates; and complex shapes such as sports racquets (tennis, racquetball, squash and the like), and golf club heads. Preferred applications include structural components suited for high temperature applications, electronic devices, or personal electronic devices (PEDs) such as cell phones, personal digital assistants (PDAs), music storage and listening devices (e.g. i-Pods), portable DVD players, electrical multimeters, mobile electronic game consoles, and mobile personal computers (such as notebook computers, etc.). Applications include both visible and nonvisible components. Nonvisible components may be in the interior of the PED, such as full or partial “frame” around the periphery of the PED, one or more separate beams and/or a number of beams in the form of a latticework, or any combination of these.

### EXAMPLES

The present invention is further defined in the following examples E1-E3 and comparative examples C1-C4. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

The following compositions 1-3 were used in the preparation of the metal coated articles of the invention as well as for the comparative examples.

Composition 1 comprises:
34.15 parts polyamide 6,6 (PA66) made of 1,6-diaminohexane and 1,6-hexanedioic acid;
15 parts amorphous polyamide B composed of 1,6-diaminohexane, 70 mole percent isophthalic acid and 30 mole percent terephthalic acid (mole percents based on total amount of dicarboxylic acids present in polyamide B);
0.40 parts Chimassorb 944 also known as poly[(6-[(1,1,3,3-tetramethylbuty)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]D;
0.20 parts Irganox 1098 also known as 3,3′-bis(3,5-di-tert-butyl-4-hydroxyphenyl)-N,N′-hexamethylenedipropionamide;
0.25 parts LICOMONT® CAV 102, a calcium salt of montanic acid crystallization promoter available from Clariant GmbH, Augsburg, Germany;
10 parts SUPER-PFLEX 200, a surface-treated, fine particle size, precipitated calcium carbonate with narrow particle size distribution available from Specialty Minerals, Inc., Bethlehem, Pa. having a typical 2% stearic acid surface treatment, average particle size 0.7 microns, +325 mesh residue of 0.03 weight percent, and surface area of 7 meters2/gram;
40 parts flat glass fibers, namely NITTOBO CSG3PA-820, 3 mm long, 28 microns wide, 7 microns thick, aspect ratio of cross-sectional axes equaling 4, having aminosilane sizing, from NITTO BOSEKI, Japan.

Pellets of composition 1 were prepared by melt blending the components above in a twin screw extruder. The glass was fed into the molten polymer matrix with a side feeder. Pelletizing/extruder temperature was approximately 280 to 310° C. Upon exiting the extruder die, they were quenched in water and pelletized. The pellets are approximately 3 mm in diameter and 5 mm in length. The pellets were then dried at 100° C. for 6-8 hours in a dehumidified dryer and then molded into a standard ISO 294 type D2 plaque of 6 cm×6 cm×2 mm, at a melt temperature of 280 to 300° C. and mold temperature of 85-105° C. using an injection molding machine to give composition 1 plaques.

Composition 2 comprises:
49 parts polyamide 6,6 made of 1,6-diaminohexane and 1,6-hexanedioic acid;
0.40 parts Chimassorb 944 also known as poly[(6-[(1,1,3,3-tetramethylbuty)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]); 0.20 parts Irganox 1098 also known as 3,3′-bis(3,5-di-tert-butyl-4-hydroxyphenyl)-N,N′-hexamethylenedipropionamide;
0.25 parts LICOMONT® CAV 102, a calcium salt of montanic acid crystallization promoter available from Clariant GmbH, Augsburg, Germany;
10 parts SUPER-PFLEX 200, a surface-treated, fine particle size, precipitated calcium carbonate with narrow particle size distribution available from Specialty Minerals, Inc., Bethlehem, Pa. having a typical 2% stearic acid surface treatment, average particle size 0.7 microns, +325 mesh residue of 0.03 weight percent, and surface area of 7 meters2/gram; 40 parts glass fibers, namely PPG 3540 of nominal length 3.2 mm, available from PPG Industries, Pittsburgh, Pa. 15272, USA.

Pellets of composition 2 were prepared by melt blending using the same method as for composition 1. Pelletizing temperature was approximately 310 to 330° C. Plaque specimens were prepared using the same method as for composition 1 at a melt temperature of 280 to 310° C. and mold temperature of 90-110° C. to give composition 2 plaques

Composition 3 comprises:
47.3 parts polyamide made from terephthalic acid, 50 mole percent (of the total diamine present) of 1,6-hexanediamine, and remaining 50 mole percent of 2-methyl-1,5-pentanediamine;
2 parts polyamide 6,6 made of 1,6-diaminohexane and 1,6-hexanedioic acid;
0.40 parts of triblend 7:1:1 of potassium iodide, cuprous iodide, and aluminum stearate, available from Ciba Specialty Chemicals;
0.25 parts Licowax OP;
10 parts SUPER-PFLEX 200, a surface-treated, fine particle size, precipitated calcium carbonate with narrow particle size distribution available from Specialty Minerals, Inc., Bethlehem, Pa. having a typical 2% stearic acid surface treatment, average particle size 0.7 microns, +325 mesh residue of 0.03 weight percent, and surface area of 7 meters2/gram; 40 parts glass fibers, namely PPG 3660 of nominal length 3.2 mm, available from PPG Industries, Pittsburgh, Pa. 15272, USA.

Pellets of composition 3 were prepared by melt blending using the same method as for composition 1. Pelletizing temperature was approximately 330 to 345° C. Plaque specimens were prepared using the same method as for composition 1 at a melt temperature of 310 to 330° C. and mold temperature of 140-160° C. to give composition 3 plaques.

The following materials were used in the experimental processes described herein.

PM847—an etching chemical solution available from Dow Chemical, Philadelphia, Pa.
PM-857—An activating solution available from Dow Chemical, Philadelphia, Pa.
PM-867—An accelerator solution available from Dow Chemical, Philadelphia, Pa.
PM-980R and S—an electroless nickel plating solution available from Dow Chemical, Philadelphia, Pa.
PM-941—an etching solution from Dow Chemical, Philadelphia, Pa.
PM-955—a neutralizer solution from Dow Chemical, Philadelphia, Pa.
PM-964—an accelerator solution from Dow Chemical, Philadelphia, Pa.
PM-980—an electroless nickel plating solution available from Dow Chemical, Philadelphia, Pa.
Conductron DP—an activator solution from Dow Chemical, Philadelphia, Pa.

### Experimental Processes

Comparative Process C1:

Step 1) The plaques as prepared above were etched for 5-15 minutes at 35-50° C. with a solution prepared by mixing in a 30 L vessel 19.5 L of ethylene glycol, 6.5 L of PM847, and anhydrous hydrochloric acid (HCl) is added until the HCl concentration is between 1.08 and 1.33 mole/L. Treatment is then followed by a water rinse for 2 minutes at room temperature, followed by an ultrasonic water rinse for 5-15 minutes at room temperature, followed by a water rinse for 1 minute at room temperature;

Step 2) The plaques from step 1 were activated with a PM-857 activator solution with mechanical stirring for 5-10 minutes at 30° C., followed by a water rinse for 2 minutes at room temperature.

Step 3) The plaques from step 2 were treated with an aqueous solution of PM-867 accelerator solution for 1-3 min at 30° C., followed by a water rinse for 2 minutes at room temperature.

Step 4) The plaques from step 3 then underwent electroless nickel plating using a PM-980 solution for 10-30 at 35-45° C. while pumping the plating solution, followed by a water rinse for 1 minute at room temperature.

Step 5) The plaques from step 4 then underwent galvanic copper plating to about a 20 micron thickness of metallic copper using an aqueous copper sulphate solution. The plaques were treated with the copper sulphate solution for 40 minutes at room temperature with mechanical stirring, followed by a water rinse for 1 minute at room temperature, and finishing by drying the plated article.

Inventive Processes E1 and E2:

Step 1) plaques were etched for 12.5 minutes at 42-43° C. with the same PM-847 acidic solution as for comparative process C1, followed by a water rinse for 1 minute at room temperature;

Step 2) The plaques from step 1 were then treated with an aqueous bifluoride solution of ammonium hydrogen bifluoride HNH₄F₂ (at 80 g/lit) at room temperature for 5 minutes (HNH₄F₂ from Merck) followed by a water rinse for 2 minute at room temperature. The bifluoride solution was prepared by mixing_{—}80 g of ammonium hydrogen bifluoride (HNH4F2)/L of deionized water.

Step 3) The plaques from step 2 were activated with PM-857 solution as in comparative process 1.

Step 4) The plaques from step 3 were then treated with an acceleration agent (PM-867) in the same manner as comparative process C1;

Step 5) The plaques from step 4 then underwent electroless nickel plating with PM-980 in the same manner as comparative process C1. For inventive process E1, treatment was for 10 minutes at 35-40° C. For inventive process E2, treatment was for 30 minutes at 35-40° C. while pumping the plating solution. Both processes E1 and E2 were followed by a water rinse for 1 minute at room temperature,

Step 6) The plaques from step 5 were then treated with a galvanic copper plating solution to about a 20 micron thickness of metallic copper, followed by a water rinse for 1 minutes at room temperature, and finishing by drying the plated article, as in comparative process 1.

Comparative Process C2 was carried out in a manner similar to inventive processes E1 and E2 with the exception that the acidic surface treatment was performed using the acidic solution in step 1 of comparative process C1 containing 80 gr/lit HNH₄F₂. Many combinations of temperature and time were tested. Temperatures from 35 to 55° C. and times from 5 to 30 min were used, but these conditions failed to produce sufficient surface roughening resulting in the inability to coat the surface with metal. No wettability of the surface was observed.

Inventive process E3:

Step 1) plaques were etched for 10 minutes at 68-70° C. with an acidic solution of sulfochromic acid and PM941 from Dow followed by two 1 minute water rinses at room temperature. This was followed by neutralization of the Cr(VI) for 3 minutes in a solution of PM955 (from Dow), under air and pump agitation, then followed by a water rinse for 1 minute at room temperature.

Step 2) The plaques from step 1 were then treated with an aqueous bifluoride solution of ammonium hydrogen bifluoride HNH₄F₂ (at 80 gm/lit) at room temperature for 10 minutes (HNH₄F₂ from Merck) followed by a water rinse for 2 minutes at room temperature.

Step 3) The plaques from step 2 were activated with an aqueous solution of Conductron DP (from Dow) for 4 minutes at 30° C., followed by water rinsing for 1 minute at room temperature.

Step 4) The plaques from step 3 were then treated with an aqueous solution of acceleration agent PM-964 (from Dow) for 5 minutes at 45° C., followed with water rinsing for 1 minute at room temperature;

Step 5) The plaques from step 4 then underwent electroless nickel plating with PM-980 in the same manner as comparative process C1 for 10-30 minutes at temperature of 35-40° C., followed by a water rinse for 1 minute at room temperature,

Step 6) The plaques from step 5 were then treated with a galvanic copper plating solution used above to about a 20 micron thickness of metallic copper, followed by a water rinse for 1 minute at room temperature, and finishing by drying the plated article, as in comparative process 1.

Comparative process C3: Same as process E3 but step 2 was omitted.

Comparative process C4 was carried out in a manner similar to inventive process E3 with the exception that the acidic surface treatment was performed using a single solution of sulfochromic acid containing 80 gr/lit HNH₄F₂. Temperatures from 50 to 80° C. and times from 5 to 20 min were used, but these conditions failed to produce sufficient surface roughening resulting in the inability to coat the surface with metal. No wettability of the surface was observed.

Peel Strength

Peel strength of the metal coated articles (measures the strength of the copper-polymer bond strength) was measured by a Z005 tensile tester (Zwick USA LP, Atlanta, Ga.) with a load cell of 2.5 kN using ISO test Method 34-1. An electroplated plaque was fixed on a sliding table which was attached to one end of the tensile tester. Two parallel cuts 1 cm apart were made into the metal surface so that a band of metal on the surface 1 cm wide was created. The table slid in a direction parallel to the cuts. The 1 cm wide copper strip was attached to the other end of the machine, and the metal strip was peeled (at a right angle) at a test speed of 50 mm/min (temperature 23° C., 50% relative humidity). The peel strengths of each example and comparative examples are shown in Tables 1 and 2 (e.g., the peel strength of E1 is 7.1 Newtons per centimeter).

TABLE 1
Peel Strength

| | E1 | E2 | C1 | C2 | E3 | C3 | C4 |
|---|---|---|---|---|---|---|---|
| Composition 1 | 17.5 | 22.4 | 7.1 | 0 | | | |
| Composition 2 | 24.5 | 34.4 | 19.6 | 0 | | | |
| Composition 3 | | | | | 8.8 | 6.5 | 0 |

Peel strength values are in N/cm

Table 1 shows an improvement in peel strength of at least 25% is obtained for E1 and E2 when the bifluoride solution treatment and acidic solution treatment were applied in separate steps during the surface preparation than when a single solution of acid and bifluoride are applied in a single step (C2) or when no bifluoride step is used (C1).

Table 1 also shows that the use of a solution of sulfuric acid (C3) or a solution of sulfuric acid and fluoride (300 to 350 g/lit), C4, followed by additional acid treatment with 25% H2SO4 in H2O, does not produce polymer surfaces suitable to sustain metal coating in any of the examples. However, treatment of the polymeric surface with sulfuric acid in one step followed by treatment with a bifluoride solution in the second step provide a polymeric surface which, when coated with metal, provides a metal bonded article having an improvement in peel strength of at least 33% over C3 and C4.

What is claimed is:

1. A process for applying a metal coating to a polymeric article, the process comprising the steps of:
i) treating the polymeric article with an acidic solution to obtain an acid treated polymeric article;
ii) treating the acid treated polymeric article with a bifluoride solution having a pH which is higher than the acidic solution of (i) to obtain a bifluoride treated polymeric article; and
iii) applying a metal coating to the bifluoride treated polymeric article to obtain a metal coated polymeric article;
wherein the metal-coated polymeric article has a peel strength which is at least 25% greater than a metal-coated polymeric article treated only with steps (i) and (iii) or treated only with steps (ii) and (iii).

2. The method of claim 1 wherein step (ii) is performed before step (i).

3. The method of claim 1 wherein said polymeric article further comprises from about 10 weight % to about 70 weight % reinforcing fibers.

4. The method of claim 3 wherein the reinforcing fibers comprise glass fibers, carbon fibers, chopped glass fibers, chopped carbon fibers, or combinations of these.

5. The method of claim 1 wherein the polymeric article further comprises from about 1 weight % to about 60 weight % of a mineral filler.

6. The method of claim 5 wherein the mineral filler is calcium carbonate.

7. The method of claim 1 wherein the polymeric article comprises a polyamide.

8. The method of claim 7 wherein said polyamide comprises a blend of from about 20 weight percent to about 80 weight percent aliphatic polyamide and from about 20 weight percent to about 80 weight percent semiaromatic polyamide, wherein each weight percent of said polyamides is based on the total weight of the aliphatic polyamide and semiaromatic polyamide.

9. The method of claim 7, wherein said polyamide comprises poly(c-caprolactam), poly(hexamethylene hexanediamide), poly(hexamethylene isophthalamide), poly(hexamethylene terephthalamide), or combinations of them.

10. A process for applying a metal-coating to a polymeric article, the process comprising the steps of:
(iv) treating the polymeric article with an acidic solution to obtain an acid treated polymeric article;
(v) treating the acid treated polymeric article with a bifluoride solution having a pH which is higher than the acidic solution of (iv) to obtain a bifluoride treated polymeric article; and (vi) applying a metal coating to the bifluoride treated polymeric article to obtain a metal coated polymeric article;
wherein the metal-coated polymeric article has a peel strength which is at least 25% greater than a metal-coated polymeric article in which steps (iv) and (v) are performed in a single step using one solution comprising the components of the acidic and bifluoride solutions.

11. The method of claim 10 wherein step (v) is performed before step (iv).

12. The method of claim 10 wherein said polymeric article further comprises from about 10 weight % to about 69 weight % reinforcing fibers.

13. The method of claim 12 wherein the reinforcing fibers comprise glass fibers, carbon fibers, chopped glass fibers, chopped carbon fibers, or combinations of these.

14. The method of claim 10 wherein the polymeric article further comprises from about 1 weight % to about 60 weight % of a mineral filler.

15. The method of claim 14 wherein the mineral filler is calcium carbonate.

16. The method of claim 10 wherein the polymeric article comprises a polyamide.

17. The method of claim 16 wherein said polyamide comprises a blend of from about 20 weight percent to about 80 weight percent aliphatic polyamide and from about 20 weight percent to about 80 weight percent semiaromatic polyamide, wherein each weight percent of said polyamides is based on the total weight of the aliphatic polyamide and semiaromatic polyamide.

18. The method of claim 16, wherein said polyamide comprises poly(ε-caprolactam), poly(hexamethylene hexanediamide), poly(hexamethylene isophthalamide), poly(hexamethylene terephthalamide), or combinations of thereof.

19. An article prepared from the method of claim 1 in the form of components suitable for use in high temperature applications, toys, appliances, power tools, or industrial machinery, electronic devices, personal electronic devices, cell phones, personal digital assistants, music storage and listening devices, portable DVD players, electrical multimeters, mobile electronic game consoles, mobile personal computers, notebook computers.

20. An article prepared from the method of claim 10 in the form of components suitable for use in high temperature applications, toys, appliances, power tools, or industrial machinery, electronic devices, personal electronic devices, cell phones, personal digital assistants, music storage and listening devices, portable DVD players, electrical multimeters, mobile electronic game consoles, mobile personal computers, notebook computers.
